(19) United States
(12) Patent Application Publication
(10) Pub. No.: US 2002/0098862 A1
(43) Pub. Date: Jul. 25, 2002

(54) Wireless mobile phone with inverted placement of antenna and input keypad

(76) Inventor: Eric Engstrom, Kirkland, WA (US)

Correspondence Address: COLUMBIA IP LAW GROUP, PC, 10260 SW GREENBURG ROAD, SUITE 820, PORTLAND, OR, 97223, US

(21) Appl. No.: 09/767,526

(22) Filed: Jan. 22, 2001

(51) Int. Cl. H04M 1/00

(52) U.S. Cl. 455/550; 455/575; 455/90; 379/433.01

(57) ABSTRACT

A wireless mobile phone includes a body casing having a top end and a bottom end. In accordance with a first aspect, the device also includes an ear speaker disposed at the top end, and an antenna disposed and extruded from the bottom end. In accordance with another aspect, the input keys are also disposed at the top end, and a display screen is disposed at the bottom end (beneath the input keys). As a result, a user's concern with electromagnetic radiation exposure to his/her brain may be reduced. Further, accessibility to the input keys for thumb manipulations is improved.

### BACKGROUND OF THE INVENTION

1. Field of the Invention

The present invention relates to the field of wireless mobile phones. More specifically, the present invention relates to the configuration of the ear speaker, the antenna, the input keypad and the display of a wireless mobile phone.

2. Background Information

Advances in computer and telecommunication technology have led to wide spread adoption of mobile client devices, in particular, wireless mobile phones. The term “wireless mobile phone” as used in herein (in the specification and in the claims) refers to the class of telephone devices equipped to enable a user to make and receive calls wirelessly, notwithstanding the user's movement, as long as the user is within the communication reach of a service or base station. The term “wireless mobile phone” is to include the analog subclass as well as the digital subclass (of all signaling protocols).

FIG. 1 illustrates a typical prior art wireless mobile phone. As illustrated, prior art wireless mobile phone 100 typically includes input keypad 102, “talk” and “end talk” buttons 104, cursor control buttons 106, display screen 108, antenna 110, ear speaker 112 and microphone 114, disposed relative to each other as shown. Wireless mobile phone 100 also includes palm-sized body casing 116 with top end 118a and bottom end 118b. Input keypad 102, disposed near bottom end 118b, facilitates a user in providing numeric or alphanumeric inputs, whereas “talk” and “end talk” buttons 104, disposed in the mid-section of phone 100, are used to start and end a call. Display screen 108, disposed neartop end 118a, is used to echo numeric or alphanumeric inputs entered by a user, as well as to display various menu options, control information, and so forth. Cursor control buttons 106, disposed in the mid-section of phone 100, are used to facilitate a user in making various menu and/or option selections. Microphone 114, also disposed near bottom end 118b, is used to facilitate the user in providing audio input, whereas ear speaker 112, disposed near top end 118a, is used to facilitate outputting for the user, received audio. Antenna 110, disposed at and extruded from top end 118a, is used to send and receive signals, including audio as well as control signals (in a modulated or digitized manner).

Thus, by virtue of the configuration, with ear speaker 112 and antenna 110 disposed at top end 118a, and microphone 114 disposed at bottom end 118b, antenna 110 is inevitably close to the lower right/left brain of a user during operation, giving rise to user concerns with insubstantial amount of electromagnetic radiation to the lower right/left brain. On another issue of lesser controversy, but nevertheless of substantial interest is the fact that, by virtue of the configuration, it is not very convenient to manipulate the input keys of input keypad 102 with the user's thumb. To do so, phone 100 has to be held in a manner with only lower portion 124b resting on the user's palm, and the remaining upper portion 124a overhanging the user's palm unsupported (assuming that the length dimension of phone 100 is in the range of the size of an average human hand, also known as palm-sized).

Therefore, a more user friendly design, in particular, one that reduces user concerns with the potential health hazard due to electromagnetic radiation, and/or improve thumb manipulability of the keypad, is desired.

### SUMMARY OF THE INVENTION

A wireless mobile phone includes a body casing having a top end and a bottom end. In accordance with a first aspect of the present invention, the device also includes an ear speaker disposed at the top end, and an antenna disposed and extruded from the bottom end. In accordance with another aspect of the present invention, the input keys are also disposed at the top end, and a display screen is disposed at the bottom end (beneath the input keys).

As a result of the arrangement, user concerns with electromagnetic radiation exposure to the brain may be reduced. Further, accessibility to the input keys for thumb manipulations is improved.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates a typical prior art wireless mobile phone;

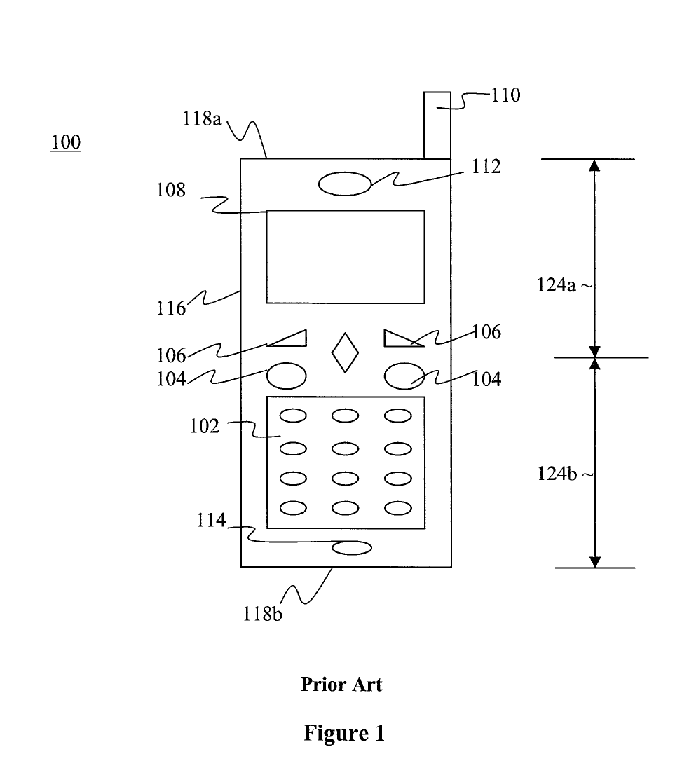

FIG. 2 illustrates a wireless mobile phone of the present invention, incorporated with the downward extruded antenna and the thumb friendly keypad of the present invention, in accordance with one embodiment;

FIG. 3 illustrates an internal component view of the wireless mobile phone of the present invention, in accordance with one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention. The phrase “in one embodiment” will be used repeatedly, however the phrase does not necessarily refer to the same embodiment, although it may.

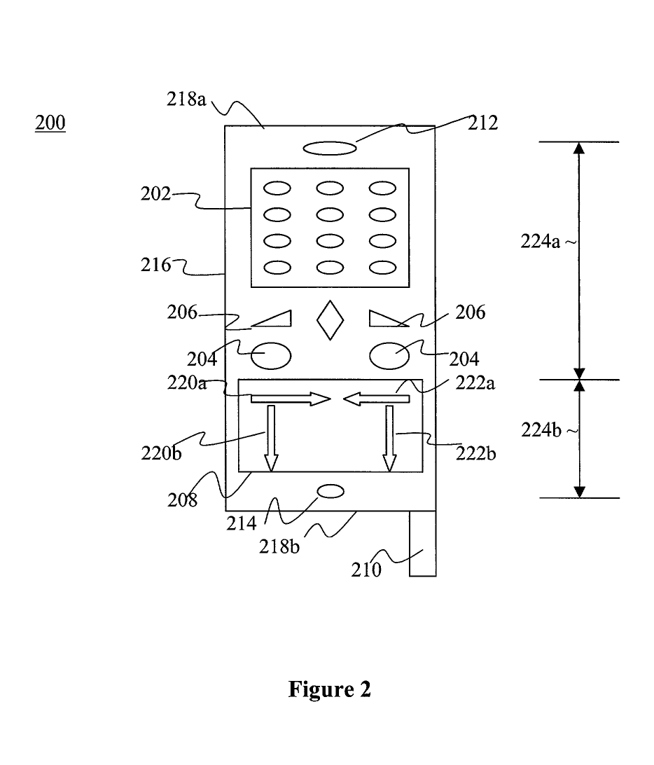

Referring now to FIG. 2, wherein a front view of a wireless mobile phone 200, incorporated with the teachings of the present invention, in accordance with one embodiment, is shown. As illustrated, similar to the earlier described typical conventional wireless mobile phone, wireless mobile phone 200 of the present invention includes input keypad 202 having a number of input keys, “talk” and “end talk” buttons 204, cursor control buttons 206, display screen 208, antenna 210, ear speaker 212 and microphone 214. Wireless mobile phone 200 also includes palm-sized body casing 216 with top end 218a and bottom end 218b. Each of these elements is used to provide the same functionality as the functionality provided by the corresponding element of prior art phone 100 described earlier, that is for the input of numeric or alphanumeric data, for starting and ending a call, and so forth. However, unlike prior art phone 100, antenna 210 and a corresponding transceiver (not shown) are advantageously relocated to be disposed near bottom end 218b, while ear speaker 212 remains disposed at top end 218a. Antenna 210 is designed to extend outward in the downward direction away from bottom end 218b. As a result, during operation, by virtue of the configuration, with ear speaker 212 disposed at upper end 218a and antenna 210 disposed and extruded from bottom end 218b, antenna 210 is likely to be located away from a user's chin. More importantly, antenna 210 is likely to be located much further away from a user's brain, when compared to prior art mobile phone 100, thereby possibly reducing a user's concern with the risk of electromagnetic radiation exposure to the user's brain.

Note that top end 218a and bottom end 218b are objectively determined. A device such as wireless mobile phone 200 having display 208 necessarily has a display orientation. For example, textual data are either rendered from left to right and top to bottom, as denoted by arrows 220a and 220b, as in the case of the English language, or right to left and top to bottom, as denoted by arrows 222a and 222b, as in the case of the Hebrew language, or top to bottom and right to left, as denoted by arrows 222b and 222a, as in the case of the Chinese language. Thus the manner in which textual data are rendered definitively defines which end is the top end, and which end is the bottom end of wireless mobile phone 200. Accordingly, an element A of phone 200 is necessarily above element B of phone 200, and element B is necessarily beneath element A, if element A is closer to the objectively determinable top end of phone 200 (or element B is closer to the objectively determinable bottom end of phone 200).

In addition to the above described advantageous relocation of the antenna 210 to bottom end 218b, for the illustrated embodiment, the disposition of input keypad 202 and display 208 of wireless mobile phone 200 are also advantageously transposed. That is, unlike prior art phone 100, input keypad 202 is advantageously disposed near upper end 218a, while display 208 is disposed near lower end 218b, beneath input keypad 202. The configuration advantageously provides improved accessibility for a user's thumb to manipulate the input keys of input keypad 202. Assuming again phone 200 has a length dimension in the range of the size of an average human hand (i.e. palm-sized), the configuration allows more of phone 200, approximately ⅔ of the body length of phone 200, section 224a, to be resting on the palm of the user, and only about ⅓ of the body length of phone 200, section 224b, overhanging the palm of the user, thereby allowing input keypad 202 to be manipulated by the user's thumb in a more steady manner.

Thus, it can be seen from the above description, wireless mobile phone 200 of the present invention may reduce users concerns with electromagnetic radiation exposure to their brains, and provides improved thumb manipulability for the input keypad.

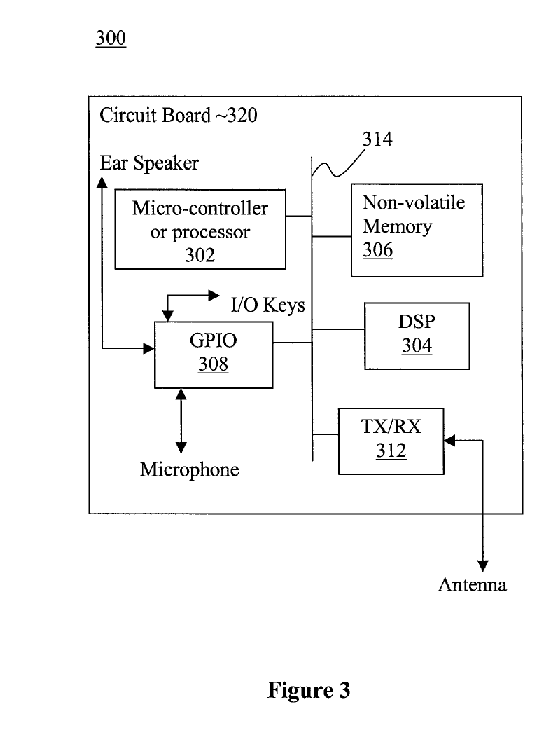

FIG. 3 illustrates an architecture view of a wireless mobile phone 300, in accordance with one embodiment. As illustrated, wireless mobile phone 300 includes elements found in conventional mobile client devices, such as microcontroller/processor 302, digital signal processor (DSP) 304, non-volatile memory 306, general purpose input/output (GPIO) interface 308, and transmit/receive (TX/RX) 312 (also known as a transceiver), coupled to each other via bus 314, and disposed on a circuit board 320. Except for the placement to support the earlier described relative disposition of the ear speaker and the antenna, and the relative disposition of the input keypad and the display, each of these elements performs its conventional function known in the art, and is intended to represent a broad range of such element. In particular, TX/RX 312 may support one or more of any of the known signaling protocols, including but are not limited to CDMA, TDMA, GSM, and so forth. Accordingly, the elements will not be further described.

Thus, a wireless mobile phone having a novel relatively disposition of the ear speaker and the antenna to reduce a user's concern with the risk of electromagnetic radiation exposure to the user's brain, and a novel relatively disposition of the input keypad and the display to improve thumb manipulability of the keypad has been described. While the present invention has been described in terms of the above illustrated embodiments, in particular, in term of wireless mobile phones, those skilled in the art will recognize that the invention is not limited to the embodiments described. The present invention can be practiced with modification and alteration within the spirit and scope of the appended claims, or on other wireless communication devices. Thus, the description is to be regarded as illustrative instead of restrictive on the present invention.

What is claimed is:

1. A wireless mobile phone comprising:
a body casing having a top end and a bottom end;
an ear speaker internally disposed near said top end;
an input keypad proximately disposed near said top end;
a display screen proximately disposed near said bottom end; and
an antenna disposed and extruded from said bottom end.

2. A wireless mobile phone comprising:
a body casing having a top end and a bottom end;
an ear speaker internally disposed near said top end; and
an antenna disposed and extruded from said bottom end.

3. The wireless mobile phone of claim 2, wherein the wireless mobile phone further comprises a transceiver internally disposed near said bottom end.

4. The wireless mobile phone of claim 2, wherein the wireless mobile phone further comprises a plurality of input keys proximately disposed near said top end.

5. The wireless mobile phone of claim 2, wherein the wireless mobile phone further comprises a display screen proximately disposed near said bottom end.

6. The wireless mobile phone of claim 2, wherein the body casing has palm sized dimensions.

7. The wireless mobile phone of claim 2, wherein the wireless mobile phone is a digital type.

8. A wireless mobile phone comprising:
a body casing having a top end and a bottom end;
a plurality of input keys proximately disposed near said top end; and
a display screen proximately disposed near said bottom end, beneath said input keys.

9. The wireless mobile phone of claim 8, wherein the wireless mobile phone further comprises an ear speaker internally disposed near said top end.

10. The wireless mobile phone of claim 8, wherein the wireless mobile phone further comprises an antenna disposed and extruded from said bottom end.

11. The wireless mobile phone of claim 10, wherein the wireless mobile phone further comprises a transceiver internally disposed near said bottom end.

12. The wireless mobile phone claim 8, wherein the body casing has palm sized dimensions.

13. The wireless mobile phone of claim 8, wherein the wireless mobile phone is a digital type.
